(19) United States
(12) Patent Application Publication
(10) Pub. No.: US 2013/0256220 A1
(43) Pub. Date: Oct. 3, 2013

(54) In-situ method and apparatus for decontaminating sites contaminated by hydrocarbons

(71) Applicants: R. Keith Barker, Walhalla, SC (US); Fred C. Hough, JR., Jacksonville, FL (US); David S.T. Pearl, Reisterstown, MD (US)

(72) Inventors: R. Keith Barker, Walhalla, SC (US); Fred C. Hough, JR., Jacksonville, FL (US); David S.T. Pearl, Reisterstown, MD (US)

(73) Assignee: Holystone LISA, LLC

(21) Appl. No.: 13/506,151

(22) Filed: Mar. 30, 2012

(51) Int. Cl. C02F 3/24

(52) U.S. Cl. 210/610; 210/622; 261/76

(57) ABSTRACT

Contaminated brownfields are successfully and efficiently remediated by the sequential synchronized treatment of the native groundwater in the contaminated site, both mechanically and biologically, in a closed-loop system.

The mechanical treatment comprises a high-intensity air sparger, and the biological treatment comprises a bacterial incubator initially filled with untreated (dirty) groundwater, the bacterial growth preferably being facilitated by a sample of the native bacteria in the site and/or is supplied with non-native bacteria.

### FIELD OF THE INVENTION

The present invention relates to the remediation of hydrocarbon contaminated sites, such as building sites (referred to in the industry as “brownfields”).

### BACKGROUND OF THE INVENTION

A significant percentage of buried underground tanks and their piping, hoses and other connections—which are filled with gasoline, diesel fuel, ethanol and/or other hydrocarbons—are inevitably subject to corrosion, thereby resulting in various degrees of leakage. This leakage may go on for many years—even minimal initially or largely undetected—and may ultimately lead to the contamination and pollution of the building site as well as adjacent properties. Once detected, emergency measures are usually taken in an attempt to clean up the site promptly and curtail further pollution. However, this is usually inefficient and may generate extensive litigation (including possible claims for punitive damages) as well as various governmental restrictions and penalties: Meanwhile, the polluted property is tainted, cannot be used as collateral, may be uninsurable, and difficult to sell or develop; moreover, the owners are subject to indefinite liabilities.

Most of these contaminated brownfields—some of which have been abandoned altogether—are located in commercial areas that are potentially very valuable, thereby affecting the commercial development and use of the brownfields and the respective overall areas. There are many brownfields scattered throughout the United States and, indeed, throughout the world. In the State of Florida, alone, and as stated in the January, 2012 report issued by the Florida Department of Environmental Protection: “As of December 2011, the total number of contaminated sites exceeded 25,124 of which 17,396 are eligible for state funding.”; and the clean-up funds are drying up.

Indeed, more of these brownfields (in the United States of America and worldwide) will be coming “on board” in the future. It's a growing problem. It's inevitable.

The typical remedy, if exercised at all, has been to dig up the site (and likely the buried tanks as well) and haul the contaminated soil to an authorized governmental approved landfill. However, this remedy is often unsuccessful; the pollution is only partially remediated; the property is still not usable; financing and insurance are not available; and substantial additional costs are incurred with no commensurate benefit. This results in the numerous brownfields whose commercial value has substantially deteriorated.

Another proposed “remedy” is to introduce an enzyme, surfactants and/or nutrients into the contaminated soil to encourage the microscopic native bacteria (the microbes) in the soil to consume or “eat” the leaked hydrocarbons. Examples are the Stillman U.S. Pat. No. 5,160,488; the Stillman, et al. U.S. Pat. No. 5,160,525; and the Battistani U.S. Pat. No. 3,635,797 (the latter issued in 1972). In some cases, out in the field, bags of the enzyme are merely emptied or “dusted” on the surface of the contaminated site—a very inefficient method. These prior bio-remedial methods constitute interesting proposals but, unfortunately, have not been commercially successful, nor universally adopted; and, as a result, have been largely relegated to the dustbin of history as a series of failed experiments.

Nevertheless, the disclosures and teachings of these three (3) prior art patents are incorporated by reference herein in their entirety.

In a commercially-related environmental area, and starting in the early 1980's, Mr. Fred C. Hough, Sr. (father of one of the co-inventors herein) had designed and developed a portable (or transportable) high-powered hydrocarbon “sparger” (air mixing) equipment for the efficient clean up of hydrocarbon contaminated sites. These spargers utilize a high-intensity mass-transfer technique that removes hydrocarbons down to undetectable levels. As an example, these spargers are capable of delivering individual flow rates of up to 400 gallons per minute.

An entire product line of these spargers is now available from Petroleum Recovery Systems, Inc., 100 South Jackson Avenue, Jacksonville, Fla. 32220.

These spargers have been used for the attempted remediation of surface spills and underground contaminated sites. Traditionally, the recovered “clean” groundwater has been released to flow to (and through) adjacent sewers and outlets and has not been recirculated back into the contaminated site for further processing. Basically, by merely cleaning the groundwater and not the soil, the groundwater becomes dirty again as the water table rises and falls.

Neither of these respective and individual technologies—enzyme enhanced bacterial remediation on the one hand, nor high-intensity sparging on the other—has been completely successful for the remediation of below-ground hydrocarbon contamination; and thus—for that specific purpose—have been largely discontinued.

Moreover, these respective technologies have co-existed in their respective realms for approximately thirty years; yet no one to date has ever combined these respective technologies—much less utilizing the continual recycling of the indigenous “native” groundwater—to achieve a substantial stepwise improvement in the art.

In another development, various proposals have been made in the past for the in-situ remediation of contaminated sites. Examples are these: Corey, et al. U.S. Pat. No. 4,832,122 issued in 1989 and the Looney, et al. U.S. Pat. No. 5,480,549 issued in 1996, both of which were assigned to the Department of Energy (D.O.E.).

Corey, et al. discloses injecting and extracting wells, which are preferably horizontal, and are positioned below the plume in the saturated zone and where the plume is in the vadose zone, respectively. One well injects a fluid into a saturated zone on one side of the plume, and the other well extracts the fluid together with volatized contamination from the other side of the plume.

Looney, et al. discloses a housing adapted for containing a liquid nutrient. A conduit is in fluid communication; and a gas flows through the conduit and contacts the liquid nutrient in the housing, such that a mixture of gas and nutrient vapors is delivered to the contaminated site via a system of injection and extraction wells which are configured to the site. Preferably, the nutrient is a volatile substantially non-toxic and non-inflammable organic phosphate. The nutrient and the gas may be heated to increase the vapor pressure.

While these patents ('122 and '549) appear to be very scholarly disclosures or presentations, we are not aware that these disclosures have ever been successfully commercialized, especially on a national or international basis. Nevertheless, these '122 and '549 patents are incorporated by reference herein in their entirety.

### SUMMARY OF THE INVENTION

Accordingly, it is the primary object of the present invention to alleviate the difficulties and deficiencies of the prior art by utilizing existing technologies, but in a totally different and unique combination and operating sequence—a novel synchronization of method steps—and to make substantial additions and improvements thereon, thereby effectively and efficiently remediating hydrocarbon-contaminated brownfields, and thereby providing an ideal solution to a problem of long-standing.

By utilizing the present invention, the potentially-valuable commercial brownfields will be readily cleaned up and again qualified for building and development, thereby constituting a remarkable environmental achievement, and thereby substantially stimulating the respective local construction and real estate markets.

In accordance with the teachings of the present invention, there is herein disclosed and claimed, a superior method (and a corresponding apparatus) for the efficient remediation of the underground soil in a contaminated site (a brownfield). The native groundwater is extracted from the site, thereby forming (at least one) inverted cone of depression. A first portion of the extracted native groundwater is vapor-sparged to dry out the cone of depression, thereby substantially reducing the hydrocarbons contamination therein. The sparged first portion of the native groundwater is recycled back into the cone of depression, thereby forming a controllable remediated environment—a microclimate—which becomes relatively moist and oxygen rich. Bacteria are multiplied or “farmed” (externally of the sparger), and in a second portion of the extracted groundwater. This second portion of the groundwater (with the multiplied bacteria therein) is recycled back into the microclimate (along with the sparged clean groundwater) thereby rapidly remediating the site to completely meet the required governmental standards and requirements and, especially, in remarkably less time and cost.

Preferably, a frac tank is provided, constituting an incubator for externally growing the native (and/or non-native) bacteria in the second portion of the extracted groundwater.

A surfactant (or surfactants) and/or nutrients are added to the contents of the frac tank and, preferably, a wetting agent is provided. Additionally, the frac tank may be heated for optimum results.

In a preferred embodiment, a wellpoint (constituting an extraction well) is provided for pumping out the native groundwater; and a plurality of injection holes are provided on a grid pattern around the wellpoint. Several wellpoints (each with its array of injection holes) may be provided, depending upon the particular contaminated site.

Broadly speaking, and viewed in another aspect, the present invention provides a method (and a corresponding apparatus therefor) for efficiently remediating an underground contaminated site both mechanically and biologically, respectively, and by a sequenced synchronized procedure in a closed-loop feedback system.

More specifically, the mechanical treatment includes a high-intensity air sparger, and the biological treatment includes an external incubator for the native (and/or non-native) bacteria; and the respective operations are phased-in or synchronized for maximum remediation efficiency, thereby substantially completing the remediation satisfactorily, meeting the rigid environmental requirements, and saving time and costs.

Generally speaking, the mechanical (sparging) method provides a “course” remediation. This “course” remediation is substantial; however, if continued as is, would begin to result in diminishing returns. The bacterial remediation, on the other hand, provides a “fine tuning” for a relatively rapid complete remediation; and the synchronization and sequencing of these method steps in combination—an example of which is herein illustrated and described—assures an optimum effective utilization of these respective technologies heretofore not offered nor realized in the prior art.

These and other objects of the present invention will become apparent from the following specification taken in conjunction with the enclosed drawings.

### BRIEF DESCRIPTION OF THE DRAWINGS

FIG. 1 is a schematic block diagram of the singular prior art use of a sparger in an attempt to clean up underground contaminated sites.

FIG. 2 is a graph, corresponding to FIG. 1, and showing the excessive time—at least months, sometimes years—for air-sparging an underground contaminated site (with no guaranty of a successful completion).

FIG. 3 is a further schematic block diagram, illustrating the singular use of an enzyme in an attempt to clean up underground contaminated sites.

FIG. 4 is a graph, corresponding to FIG. 3, and showing how a typical bacterial remediation of a contaminated underground site may take many months, if not years (and, again, with no guaranty of ultimate success).

FIG. 5 is a generalized schematic block diagram of the present invention, illustrating the conjoint use of sparging and bacterial remediation—a “best of both worlds” solution—which is used in a sequential and synchronized manner (as hereinafter described in detail). [It will be appreciated by those skilled in the art that other synchronized, sequential steps may be taken, consistent with the teachings of the present invention.]

FIG. 6 is a further schematic block diagram, basically detailing FIG. 5, and illustrating one embodiment of the present invention.

FIG. 7 is a graph showing the superior results of the present invention—wherein the time for a complete successful remediation of a typical contaminated site may be substantially reduced.

FIGS. 8-12 are schematic block diagrams, sequentially illustrating the methodology of a preferred embodiment of the present invention.

FIG. 13 is a schematic top plan view of a contaminated site being remediated; and illustrating schematically, at least one central wellpoint (or excavation well); a plurality of injection holes arranged in a grid pattern around the wellpoint; and one or more monitoring wells.

FIG. 14 is a cross-sectional view thereof, taken along the lines 14-14 of FIG. 13, and showing the inverted cone of depression around the wellpoint and its plume, and further showing the injection holes and the monitoring wells, respectively.

FIG. 15 is a schematic pictorial view of the spores of the native bacteria about to penetrate an enzyme and/or surfactant covering the hydrocarbon contaminant.

### GENERAL DESCRIPTION OF THE PREFERRED EMBODIMENT

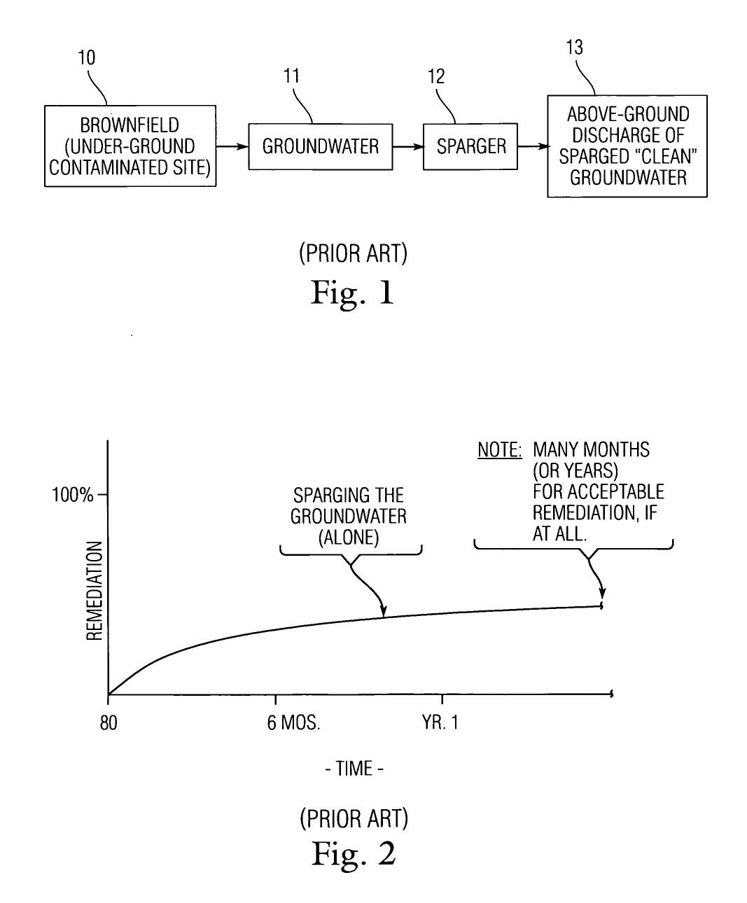

With respect to FIGS. 1 and 2, the prior art remediation of the underground contaminated site (the “brownfield”) 10 generally consists of merely pumping the groundwater 11 out of the site 10 and through a sparger 12. [More than one sparger 12 may be connected “in series” if desired.]

The discharge of the clean groundwater 11 out of the sparger 12 is invariably above ground (as at 13) as, for example to an adjacent sewer (not shown). The groundwater 11 has not been recycled back through the site 10. Again, the groundwater 11 is cleaned, but not the soil; and as the water table rises and falls, the groundwater 11 again becomes “dirty”. As a result, total remediation—meeting the rigid requirements of the governmental environmental agencies—will usually take months and; depending on the particular brownfield 10, may actually take years or be abandoned altogether.

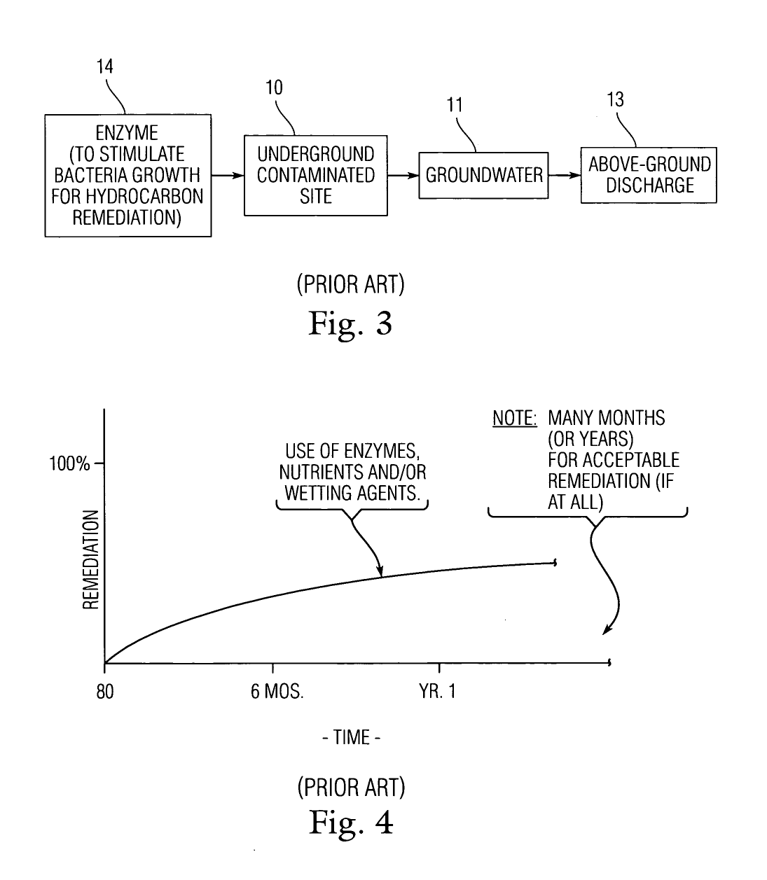

With respect to FIGS. 3 and 4, the prior art has also resorted to the use of an enzyme 14 to stimulate growth of the native bacteria in the soil for hydrocarbon remediation. (See the above-noted Stillman and Stillman, et al. patents.)

On some clean up jobs, bags of the enzyme 14 are merely sprinkled on the surface of the contaminated site 10. Any flow of the groundwater 11—if at all—is merely discharged above ground—a very wasteful and inefficient procedure—and again, there is no recycling of the native groundwater 11.

As illustrated in FIG. 4, this grossly-inefficient method of FIG. 3 will take months, if not years, for a successful completion (if at all). Like the method illustrated in FIG. 1, it may be abandoned altogether or not even attempted. The prospects for success are dim, and the number of brownfields 10 keeps rising and constitutes an impediment to the commercial development of the overall area. Indeed, the rising number of brownfields 10 gives mute testimony to the total failure of the prior art.

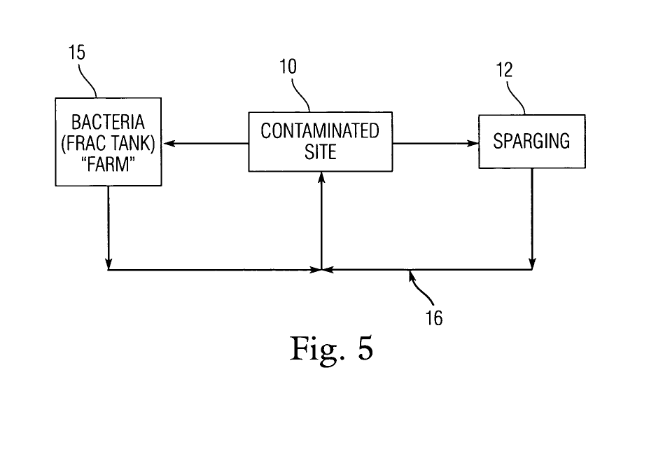

With respect to FIG. 5—and contrasting the present invention from the antiquated prior art—the sparger 12 is used in conjunction with an external farm or incubator 15 for growing the native (or non-native) bacteria; and in a synchronized, sequential manner (as hereinafter illustrated and disclosed in detail) and in a closed-loop positive-feedback system, as at 16.

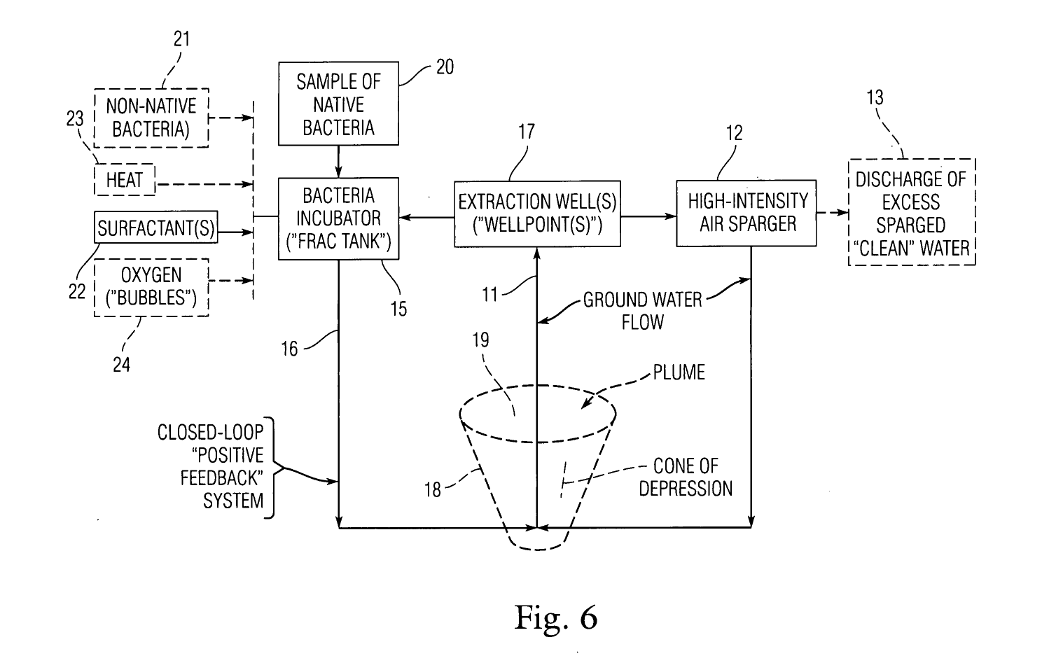

As illustrated in FIG. 6, the system includes at least one extraction well (or wellpoint) 17 for drawing out the groundwater 11, thereby forming an (inverted) cone of depression 18 with its plume 19. This cone of depression 18 constitutes a man-made void or depression in the water table. The bacterial incubator 15 (referred to in the art as a “frac” tank) is “inoculated” or seeded with a sample of the native bacteria 20 (and/or non-native bacteria 21) and as indicated schematically, one or more surfactants 22—again, see the above-referenced Stillman and Stillman, et al. patents—are added to the incubator/frac tank 15. If desired, heat 23 and oxygen bubbles 24 may be provided. The result is the closed-loop “positive feedback” system 16.

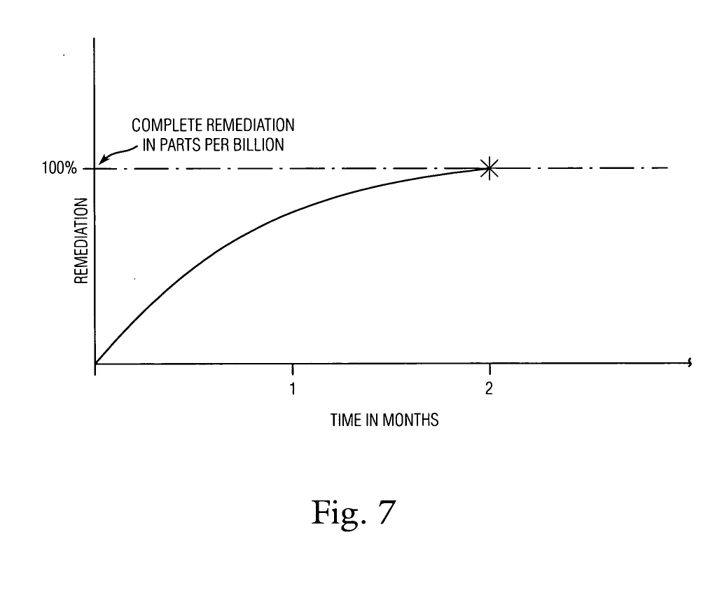

As illustrated in FIG. 7, a complete 100% acceptable remediation to non-detectable levels will be achieved in a matter of several weeks or months—typically around two (2) months—depending upon the particular site 10 and in sharp contrast to the prior art necessity for many months (if not years), for a complete remediation meeting the rigid standards established by the various governmental agencies. Indeed, in the antiquated prior unit, complete success was often illusory; and the project was sometimes abruptly discontinued.

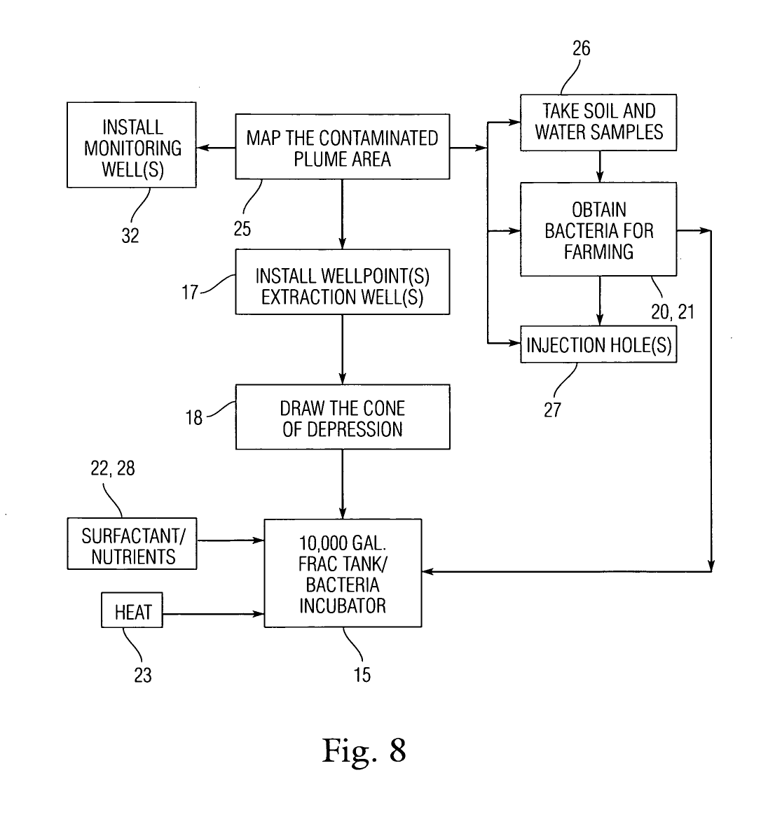

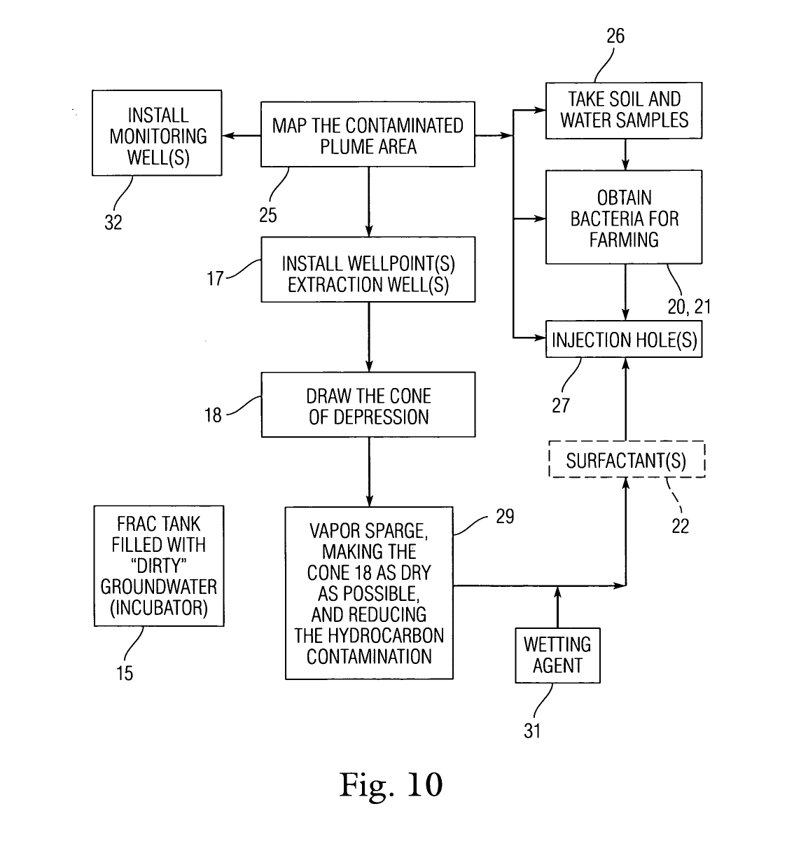

A preferred embodiment of the present invention is illustrated schematically in FIGS. 8-12, respectively, providing a synchronized rendition of the individual method steps.

Accordingly, and with this in mind, a step-by-step outline of the methodology of one embodiment of the present invention is as follows: [Of course, it will be understood by those skilled in the art, that re-arrangements of these method steps and/or further improvements, may be equally feasible in practicing the present invention.]

### EXAMPLE ONE

### (FIG. 8-12)

### A) Prior to Equipment Installation:

a) Map contamination plume area (as at 25).

b) Take soil and water samples (as at 26).

c) Harvest the native bacteria 20 for farming (and/or be supplied with non-native bacteria 21).

### B) Wellpoint Installation:

a) Install one or more wellpoint (extraction wells) 17 (three to four feet below the center of the contamination plume area 19. [Generally speaking, an extraction well 17 should be centered within approximately six feet of the furthest extension of the plume 19.]

b) Drill four-inch (4″) air and water injection holes 27 every six feet (6′) in a grid pattern extending six feet (6′) beyond the contaminated area.

### C) Equipment Installation:

a) Well Point System (Extraction Well 17). [Preferably, the radial gap at the top of the extraction well 17 should be sealed (for example, with clay, not shown) to avoid any problems.]

b) Sparging System 12.

c) 10,000 gallon Frac Tank 15.

d) Heating Equipment.

e) Injection and Piping Systems (as necessary).

### D) Drawing the Cone of Depression for Hydrocarbon and Water Remediation: (FIG. 8).

a) Wellpoint system 17 vacuums out the groundwater 11, drawing the cone of depression 18. Partially-contaminated groundwater 11 is pumped into the 10,000 gallon frac tank 15. This partially-contaminated groundwater 11 will be injected with a concentrate of surfactants 22 and/or nutrients 28 and heated (as at 23) and then used as an incubator to grow bacteria for injection at a later time. After the frac tank 15 is filled, the groundwater 11 is diverted back to the sparger 12. The sparger 12 cleans the water to non-detectable hydrocarbon levels. At this point, the water can be re-injected or discharged off site (as at 13).

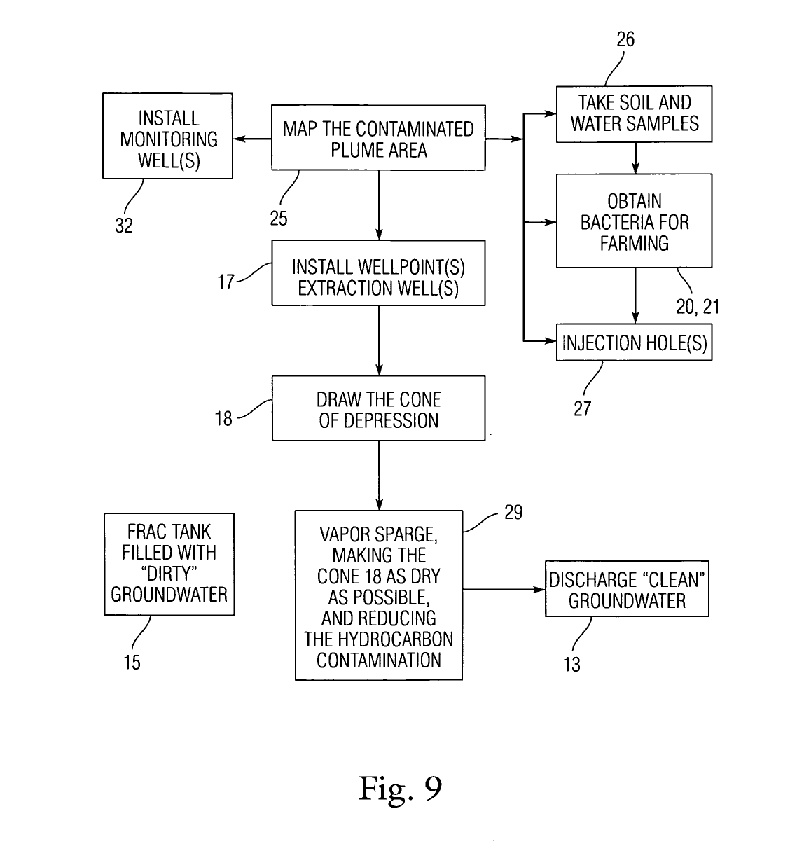

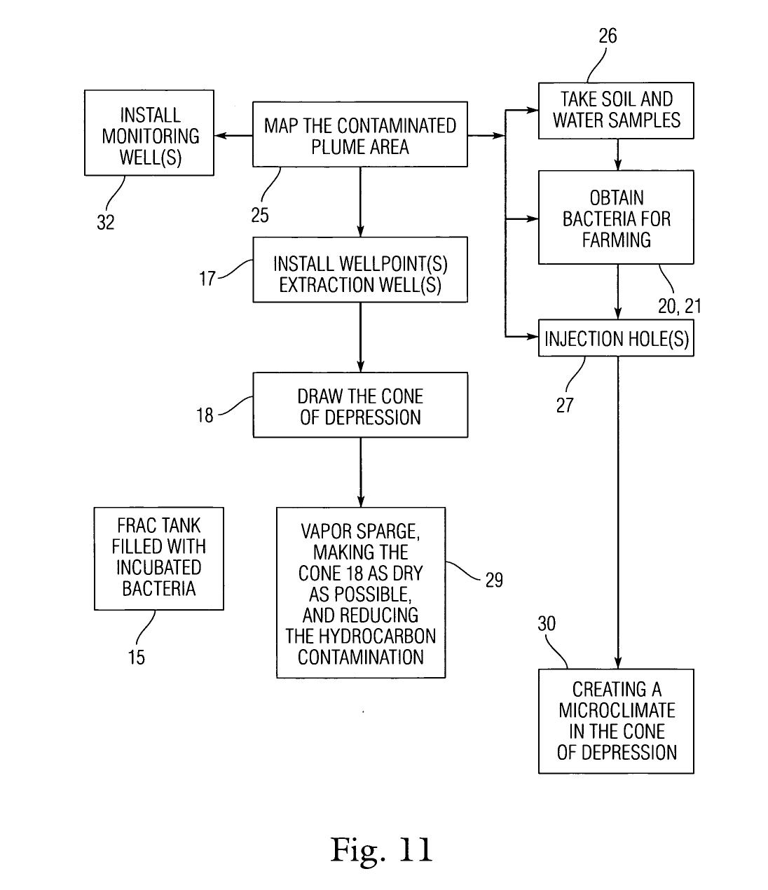

b) Once the cone of depression 18 is created, the wellpoint system 17 will be adjusted to over vacuum the cone of depression area 18, resulting in vapor extraction of air in the plume area 19 (as at 29 in FIG. 9), thus pulling air from the air/water injection holes 27 in the surface of the plume area 19. This will dry out the hydrocarbon plume area 19, thus removing most of the hydrocarbons therein. Once it is determined that the hydrocarbon level is low enough to accept the bacteria—without killing the bacteria 20, 21—, a microclimate 30 (FIG. 11) can be created encompassing the plume area 19.

### E) Creating the Microclimate:

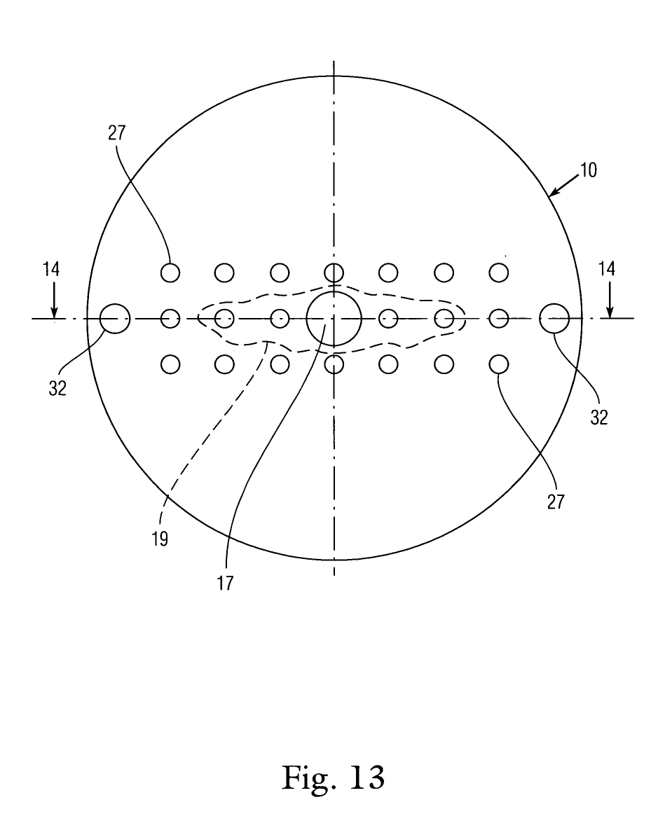

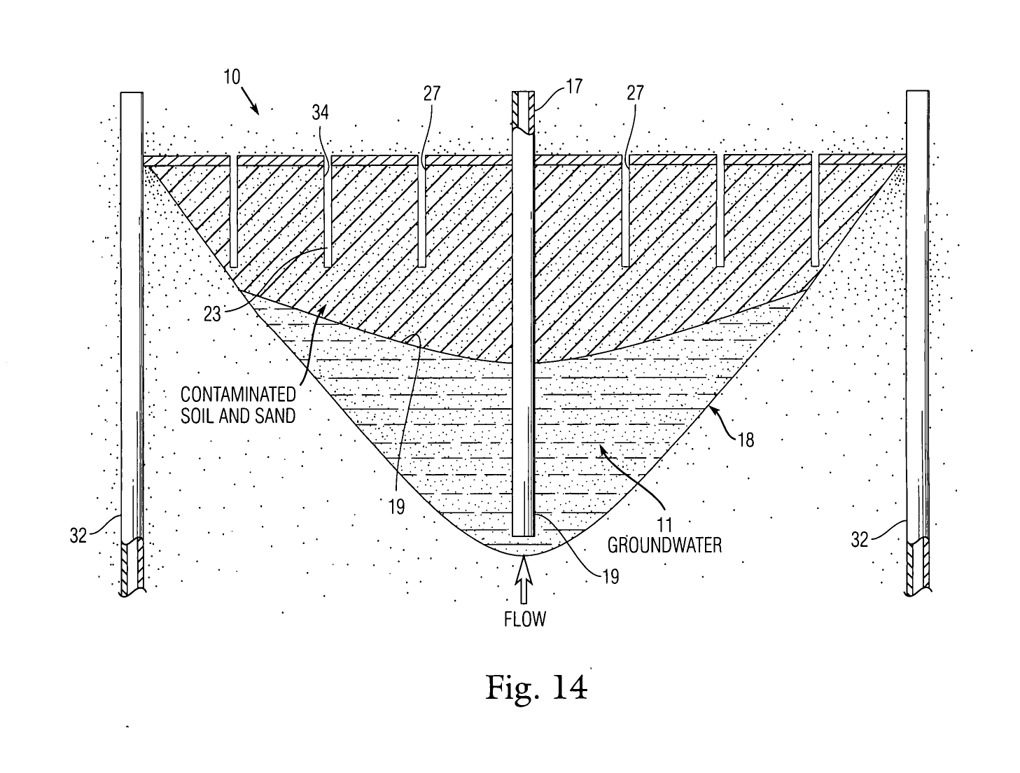

a) At this time, a wetting agent 31 will be added to the water from the sparger 12, and may be used for injecting into one or more 4″ air/water injection holes 27—see FIGS. 13 and 14—thus creating the microclimate 30 and making the plume area 19 moist and oxygen rich.

F) Adding Surfactants and/or Enzymes to the Cone of Depression:

At this point, a surfactant or surfactants 22 and/or nutrients 28 suitable to promote growth of the bacteria 20, 21 may be injected into the microclimate area 30 through the 4″ air and water injection holes 27. [Again, see the above-referenced Stillman (and Stillman, et al.) patents.]

### G) Adding the Bacteria:

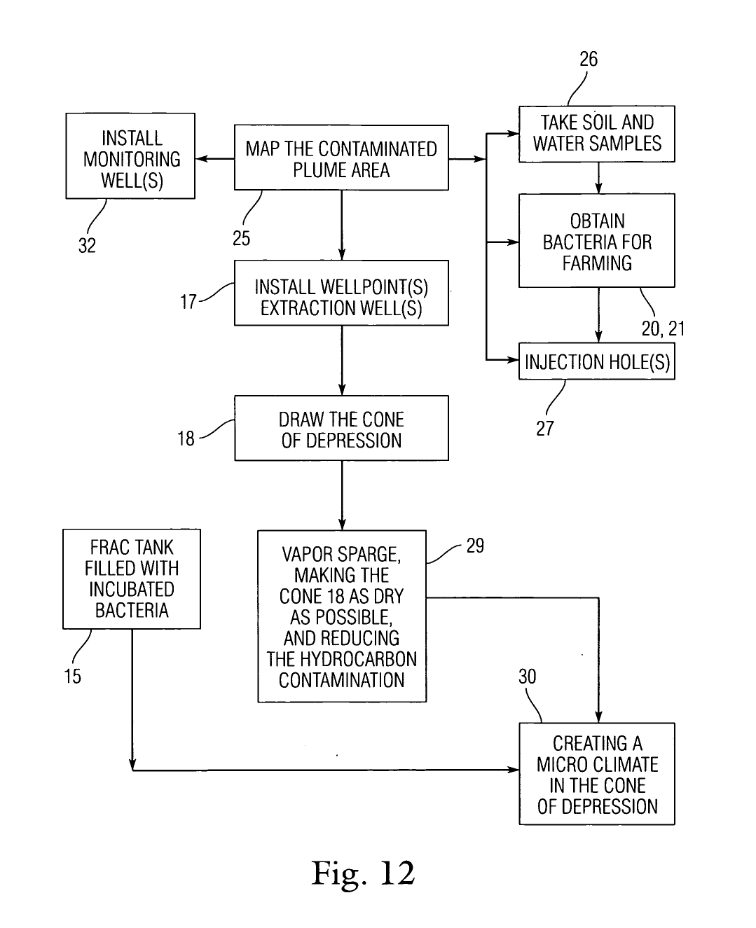

At this time, the microclimate 30 is ready to receive the bacteria 20, 21 from the frac tank 15. The frac tank bacteria water is injected into the microclimate area 30 through the 4″ air and water injection holes 27—see FIGS. 12 and 14—creating a bacteria-rich area for the bacteria to multiply and consume all of the hydrocarbons at a rapid rate throughout the microclimate area 30. Oxygen-rich water and air is being slowly pumped and re-injected into the microclimate 30 to keep oxygen and moisture levels up, while removing any CO² that is created by the bacteria growth.

Once hydrocarbons are all consumed by the bacteria, the site 10 is clean of all hydrocarbons, and the property can be sold as completely “clean” property. By the proper use of the sequential steps, we avoid premature introduction of the bacteria (microbes) which would be inefficient and wasteful. Instead, we make optimum use of the cultivated microbes.

With reference again to FIGS. 13 and 14, the extraction wellpoint 17 may, for example, be centralized within the contaminated area of the site 10; and the wellpoint 17 is surrounded by a grid formation of injection holes 27 drilled into the site 10. It will be appreciated by those skilled in the art that one or more monitoring wells 32 may be installed in the site 10.

Additionally, readings of the current remediation results may be taken at the respective monitoring wells 32; and depending upon those readings, the input to the injection holes 27 may be regulated or varied for maximum efficiency of the remediating means. This improvement is disclosed in the Hough, et al. provisional patent application, Ser. No. ______ filed on Mar. 21, 2012, the contents of which are cross-referenced and incorporated herein in their entirety.

The drying out of the soil within the cone of depression 18 (“vapor sparging” 29) will remediate much of the hydrocarbon, but not all of it. It is essential that the contaminated area 10 be conducive to the growth of native (and/or non-native) bacteria 20, 21 which will naturally eat or consume the contaminants. In order to finally clean the soil, the bacteria 20, 21 must be reintroduced into the plume area 19. In order for the bacteria to thrive, we need to make the cone of depression 18 as bacteria “friendly” as possible. We do this by adding oxygen to the plume 19 (by drying it out through air) and oxygenating the water (via the air sparger 12).

We also need to make the plume area 19 relatively moist. By making the plume oxygen enriched and moist, the bacteria are more than willing to go to work or start eating the contaminants.

We refer to creating the environment to make the bacteria conducive to consume the contaminant the “microclimate” 30. One cannot create a microclimate 30 until one takes control of the plume 19; and the first stage in that process is vapor sparging, or drying it out (as at 29).

We then reintroduce the bacteria into the microclimate by reinserting the groundwater 11 as a delivery system. By vapor sparging the contaminated soil, we are breaking down the hydrocarbon molecules and releasing carbon dioxide gas which escapes into the atmosphere without harm to the environment.

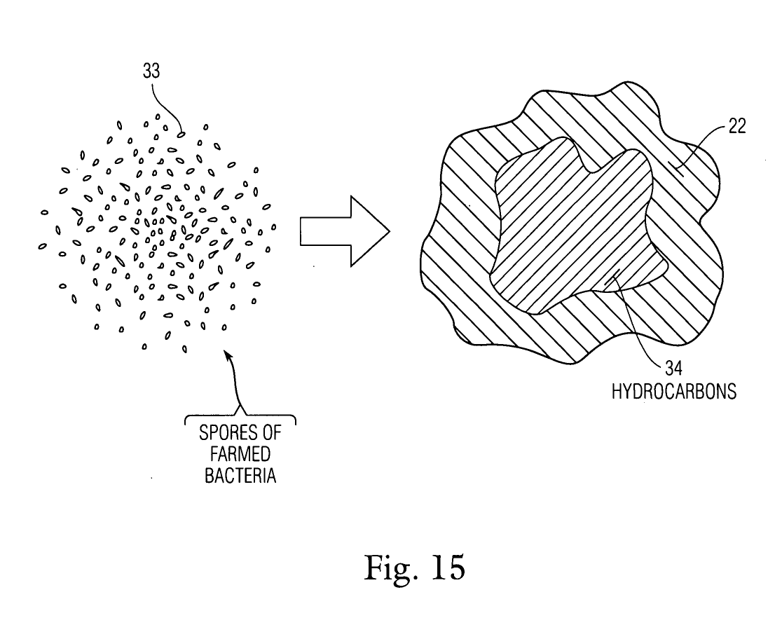

With reference to FIG. 15, the bacteria spores 33 are attracted to the enzymes and/or surfactants 22 encapsulating the hydrocarbons 34.

The present invention thus constitutes a substantial stepwise improvement in the clean up of the brownfields 10 which, prior to our invention, were largely stagnant or abandoned altogether.

Again, and in summary, by utilizing existing “off-the-shelf” technologies and equipment (heretofore used individually and without acceptable results) and by combining these technologies and equipment and making improvements thereto in a closed-loop system and having a synchronized sequential methodology, the numerous brownfields 10 may be readily remediated to meet the rigid standards required by the governmental environmental agencies and, most important, at substantially less time and cost. This is indeed a boom to the construction industry and to the commercial real estate markets in the respective areas affected by the brownfields 10—of which there are many thousands in the State of Florida alone, many more in the United States of America, and perhaps approaching (or exceeding) a million worldwide.

Obviously, many modifications may be made without departing from the basic spirit of the present invention. For example, the sequence of the method steps may be re-arranged somewhat, depending upon conditions at a particular job site and/or the priority preferences of the manager and/or technicians on the job. Accordingly, it will be appreciated by those skilled in the art that within the scope of the appended claims, the invention may be practiced other than has been specifically described herein.

1. The method of in-situ remediation of a hydrocarbon-contaminated site without removing the contaminated soil in the site, comprising the steps of extracting the native groundwater from the site and thereby forming an inverted cone of depression, initially vapor sparging a first portion of the extracted groundwater to substantially dry out the cone of depression, thereby providing a “coarse” remediation for substantially reducing the hydrocarbon contamination therein, recycling a first portion of the sparged groundwater back into the cone of depression, thereby forming a controllable remediating microclimate in the cone of depression which then becomes relatively moist and oxygen rich and ready to receive bacteria, multiplying hydrocarbon-attracted bacteria in a second portion of the extracted groundwater externally of the cone of depression and recycling the second portion of the sparged groundwater with the multiplied bacteria therein into the microclimate, thereby “fine tuning” the remediation, and thereby completely remediating the site, fully meeting the environmental standards, and effecting a substantial savings in time and costs.

2. The method of claim 1, further including the steps of providing at least one wellpoint for extracting the groundwater in the site, and further providing a plurality of injection holes arranged in a grid pattern around the wellpoint.

3. The method of claim 2, wherein a wetting agent is injected into the site via the injection holes.

4. The method of claim 1, further including the step of providing a frac tank constituting an incubator for externally growing the bacteria in the other portion of the extracted native groundwater.

5. The method of claim 4, wherein at least one surfactant and/or nutrient is added to the contents of the frac tank, and wherein non-native bacteria is added to the frac tank.

6. The method of claim 3, further including the step of adding a surfactant via the injection holes.

7. The method of in-situ remediation of a hydrocarbon-contaminated site without removing the contaminated soil in the site, comprising the steps of providing at least one wellpoint in the site and further providing a plurality of injection holes arranged in a grid pattern around the wellpoint, extracting the native groundwater from the site via the wellpoint, and thereby forming an inverted cone of depression, vapor sparging a first portion of the extracted groundwater to substantially dry out the cone of depression, thereby substantially reducing the hydrocarbon contamination therein, multiplying hydrocarbon-attracted bacteria in a second portion of the groundwater in a frac tank constituting an incubator externally of the cone of depression, adding at least one surfactant and/or nutrient to the contents of the frac tank, injecting a wetting agent in the groundwater via the injection holes in the site, recycling the sparged portion of the groundwater back into the cone of depression, thereby forming a controllable remediating microclimate in the cone of depression which then becomes relatively moist and oxygen rich and ready to receive the multiplied bacteria, and recycling the other portion of the groundwater with the multiplied bacteria therein into the microclimate, thereby completely remediating the site, fully meeting the environmental standards, and effecting a substantial savings in time and cost.

8. (canceled)

9. The method of efficiently remediating an underground contaminated site by a sequential treatment of the native groundwater in the site, both mechanically and biologically, respectively, and with a closed-loop feedback of the treated groundwater, and further including the steps of initially providing a high-intensity air sparger for mechanically treating a first portion of the native groundwater, thereby providing a “coarse” remediation, and further providing a frac tank serving as an external bacteria incubator for the biological treatment of a second portion of the native groundwater, and thereafter recirculating the treated groundwater, thereby efficiently remediating the contaminated site.

10. (without prejudice of disclaimer)

11. The method of claim 1, wherein the initial sparging of the groundwater is a high-intensity high-flow rate sparging.

12. The method of claim 11, wherein the sparging is up to 400 gallons per minute.
